(19) United States
(12) Patent Application Publication
(10) Pub. No.: US 2024/0042740 A1
(43) Pub. Date: Feb. 8, 2024

(54) TRANSPARENT OVERLAYS FOR THE PROTECTION OF INTERIOR AND EXTERIOR SURFACES

(71) Applicant: Arclin USA LLC, Roswell, GA (US)

(72) Inventors: Klaus Hofmann, Krems (AT); Guillermo Velarde, Cary, NC (US); Michel Ross, Lake Worth, FL (US); David Smith, Old Fort, TN (US)

(73) Assignee: Arclin USA LLC, Roswell, GA (US)

(21) Appl. No.: 18/223,712

(22) Filed: Jul. 19, 2023

Related U.S. Application Data
(60) Provisional application No. 63/370,348, filed on Aug. 3, 2022.

(51) Int. Cl. B32B 21/06; B32B 29/06; B32B 21/14; B32B 37/24

(52) U.S. Cl. CPC B32B 21/06; B32B 29/06; B32B 21/14; B32B 37/24; B32B 2255/12; B32B 2255/26; B32B 2307/4023; B32B 2260/028; B32B 2260/046; B32B 2307/718; B32B 2307/554; B32B 2307/5825; B32B 2307/558; B32B 2307/714; B32B 2307/584; B32B 2307/414; B32B 2307/712; B32B 2309/02; B32B 2309/12; B32B 2037/243; B32B 2305/07

(57) ABSTRACT

An article for indoor or outdoor use having resistance to damage from wear and tear and exposure to weather comprising: a coated overlay comprising an untreated alpha-cellulose core layer which optionally is ink-jet printed with ornamental decors or full area print designs that is saturated with a melamine formaldehyde (MF) resin and a coating layer coated on a top surface of the core layer, said coating layer comprising a polyurethane(meth)acrylate resin; a panel substrate of wood, plywood, or non-wood; a midlayer between the overlay and the substrate, said midlayer is a veneer, paper foil, or medium density overlay (MDO); a backer sheet is a bottom layer attached to a bottom surface of the substrate, wherein the backer sheet and midlayer are optional. The nonprinted regions of the coated overlay on the panel are transparent to visible light.

### BACKGROUND

It is widely accepted that decorative surfaces such as the surfaces one can find on cabinetry, flat pack furniture, flooring, doors, table tops, etc. need protection against mechanical abrasion and household chemical attack. This is even more the case when considering work-tops in household and in laboratories where such surfaces are subject to contact with strong acids, bases, and solvents.

It is furthermore necessary to protect exterior surfaces such as garden furniture, out-door kitchen cabinetry, fences, sidings, etc. not only against mechanical attack but also against damage caused by water ingress, humidity, heat, and UV-radiation.

Basic protection is normally provided by liquid coating that is hardened by evaporation, heat induced cure, and UV or e-beam radiation. While liquid coatings can provide protection against mechanical and chemical damage, especially when applied in a controlled industrial setting, it is nevertheless a costly, time consuming, and labor-intensive process. Even though some texturing of liquid applied protective surfaces is possible it is only feasible by means of very controlled industrial processes.

To overcome the limitations of liquid protective coating, it is now common practice to laminate certain surfaces such as laminate floors or table tops with transparent paper-based overlays saturated with melamine formaldehyde (MF) resin. The advantage of such transparent protective overlays is that they are self-bonding and can be applied together with MF saturated decor-paper in a 1-stop process on short cycle or high pressure presses, thereby minimizing application time. The disadvantage of such MF saturated overlays however is the relative low resistance to mechanical attack. Scratch resistance hardly surpassed 2N (EN 438-2, 2019, Ch. 25) and without the addition of corundum, surfaces become quickly dull from daily wear and tear. MF saturated overlays further are very brittle and cannot be easily applied on surfaces having a certain roughness, like veneers or plywood. Further, MF saturated overlays are not UV-stable and therefore not suitable for exterior applications. Since MF resins are delivered with B-staged MF resin there is sufficient flow to allow texturing up to about 100 μm during surface lamination. Certain gloss levels are possible but high gloss is only possible in a high-pressure laminate (HPL) process with back-cooling, but not in a short cycle press.

Further, classic MF impregnated overlays as described above are not suitable for boards with an inherent rougher surface structure such as softwood plywood or oriented strand board (OSB) since the uneven surface structure would telegraph through the overlay. For protection, such boards are routinely surfaced with medium density overlays (MDO) which lack the decorative and tactile experience of MF saturated overlays.

DE102020007628B4 discloses a process for the production of a laminating film or a material panel for interior use comprising the steps of a) impregnating a carrier web with an adhesion promoter, b) coating the upper side of the impregnated carrier web with a curable lacquer composition, c) at least partial curing of the lacquer composition, the adhesion promoter comprising: 70 to 90 wt. % aqueous urea formaldehyde resin solution, 5 to 20% by weight water, 1 to 9% by weight of an aqueous acrylate dispersion comprising ethoxylated trimethylolpropane triacrylate (TMPTA), 0.1 to 1% by weight hardener and 0.01 up to 1% by weight wetting agents and additives. The product has super matt surfaces with very good anti-fingerprint properties and is formed with excimer UV curing.

Foils formed with a protective top coating that is fully cured and hardened by UV or e-beam radiation can provide good mechanical hardness of the surface. However, since the surface is fully cured, texture and embossing are only possible as pre-provided by the producer. Such foils are not self-bonding and must be applied onto various substrates by hot-melt or similar adhesives.

### SUMMARY

An object of the present disclosure is to meet the demand for a durable overlay having improved mechanical and chemical properties that is either transparent or translucent prior to lamination, and is transparent to visible light upon lamination/press. The advantage of a transparent overlay is that it can be used together with any printed or solid decor as an underlay. The overlay can be embossed and textured at the time of lamination onto the to-be-protected surface, and articles comprising the overlay affixed (via self-bonding) to a substrate for use in the interior and/or exterior of modern homes and buildings, whereby the overlay can provide a surface to the substrate with gloss levels ranging from super-matt to high gloss. The overlay is formed with an untreated cellulose web that can optionally have a printing thereon. When the untreated cellulose web is not printed, the overlay is fully transparent to visible light after lamination onto the substrate. On the other hand, when the untreated cellulose web is printed, the overlay is transparent except for the printed regions upon lamination to the substrate. Such articles can be used in interior and exterior settings since they can be equipped with strong UV protection.
1. In a first aspect, the present disclosure relates to a thermally cured article (7) for indoor or outdoor use having resistance to damage from wear and tear and exposure to weather comprising:
   a coated overlay (1) comprising an untreated alpha-cellulose core layer (3) that is saturated with a melamine formaldehyde (MF) resin and a coating layer (2) coated on a top surface of the core layer (3), said coating layer (2) comprising a polyurethane(meth)acrylate resin;
   a panel substrate (4) of wood, plywood, or non-wood;
   a midlayer (5) between the overlay (1) and the substrate (4), said midlayer (5) is a veneer, melamine impregnated paper, paper foil, melamine formaldehyde (MF) resin impregnated paper or melamine urea formaldehyde (MUF) resin impregnated paper or medium density overlay (MDO);
   a backer sheet (6) is a bottom layer attached to a bottom surface of the substrate (4),
   wherein the backer sheet (6) and midlayer (5) are optional.
2. The article (7) according to sentence 1, wherein the untreated alpha-cellulose core layer (3) is a web which may have a base weight of 15-80 g/m², preferably 20-70 g/m², more preferably 20-40 g/m².
3. The article (7) according to any one of sentences 1-2, wherein the untreated alpha-cellulose core layer (3) may be saturated with a MF saturating resin to a dry weight of 60-140 g/m², or a dry weight of 80-120 g/m², or a dry weight of 90-110 g/m².
4. The article (7) according to any one of sentences 1-3, wherein the coating layer (2) may be applied and then dried and cured to give a dry weight in an amount of 20-100 g/m², or 40-80 g/m², or 50 to 100 g/m², or 60-80 g/m² or preferably 60 to 90 g/m².
5. The article (7) according to any one of sentences 1-4, wherein the article may comprise a backer sheet (6), or midlayer (5) or both a backer sheet (6) and midlayer (5).
6. The article (7) according to any one of sentences 1-5, wherein the coating layer (2) may have at least one of the following properties:
   a) Resistance to environmental impact;
   b) Mechanical properties sufficient to satisfy European Standard EN438 for high pressure laminates (HPL) of >5N;
   c) Impact resistance of HPL;
   d) Chemical and Stain resistance that meets SEFA 3 standard; and
   e) Micro scratch resistance using Martindale test method that is better than micro-corundum fortified decor paper.
7. The article (7) according to any one of claims 1-6, wherein a surface of the coating layer (2) may be chemical resistant with grade ≥4, i.e. in particular 4 or 5, measured according to EN 438-2.26: 2005, may have a scratch resistance of ≥6N, measured in accordance with EN 438-2.25: 2005, and may have change in the degree of gloss after exposure to weathering for 3500 hours in accordance with the EN 438-2.29: 2005 method, measured in accordance with EN ISO 2813 at an angle of 85°, of not more than 5 units, preferably not more than 3 units.
8. The article (7) according to any one of sentences 1-7, wherein a surface of the coating layer may have a change in the degree of gloss after exposure to weathering for 3500 hours in accordance with the EN 438-2.29 of not more than 20% compared to the initial value before weathering as set at 100%, preferably the overlay may be capable of weather exposure with minimal loss in color and surface integrity for 10 years of outdoor exposure in a location in North East United States.
9. The article (7) according to any one of sentences 1-8, wherein the article may have a weathering resistance as measured by EN 438-2.28-29:2019, to give no visible change, such as fading of the surface of the substrate (4) or of the midlayer, (5) after 3000 hours.
10. The article (7) according to any one of sentences 1-9, wherein the impregnated untreated alpha-cellulose core layer (3) may be formed with a printed untreated alpha-cellulose web wherein regions that are not printed are transparent; or the impregnated untreated alpha-cellulose core layer (3) may be formed with a nonprinted untreated alpha-cellulose web.
11. The article (7) according to any one of sentences 1-10, wherein the impregnated untreated alpha-cellulose core layer (3) may be formed with a printed untreated alpha-cellulose web.
12. The article (7) according to any one of sentences 1-10, wherein the impregnated untreated alpha-cellulose core layer (3) may be formed with a nonprinted untreated alpha-cellulose web.
13. The article (7) according to any one of sentences 1-12, wherein the untreated alpha-cellulose core layer (3) can be saturated with a melamine formaldehyde (MF) resin in a one-step or a two-step impregnation process, wherein in the first step of the two-step process, the saturating resin may comprise MF and UF resin in a MF:UF weight ratio of 0:100-100:0, or 90:10-10:90, or 98.5:1.5-99.75:0.25, and in the second step, the saturating resin may comprise MF and UF resin in a MF:UF weight ratio of 90:10-10:90, or 98.5:1.5-99.75:0.25, or 98.5:1.5-100:0.
14. In a second aspect, the present disclosure relates to a product comprising the thermally cured article according to any one of sentences 1-13 forming an outer surface thereof, wherein the product is for indoor use and is a cabinet, kitchen counter, laboratory bench, or indoor flooring, or the product is for outdoor use and is fencing, door, an outdoor kitchen surface, a façade element, roofing, a garden shed surface, a tool shed surface or outdoor flooring.
15. The product according to sentence 14, wherein the product may be for indoor use and may be a cabinet, kitchen counter, laboratory bench, or indoor flooring,
16. The product according to sentence 14, wherein the product may be for outdoor use and may be for fencing, a door, an outdoor kitchen surface, a façade element, roofing, a garden shed surface, a tool shed surface or outdoor flooring.
17. In a third aspect, the present disclosure relates to a process for forming the article (7) according to any one of sentences 1-13, comprising:
   printing on the untreated alpha-cellulose core layer (3);
   saturating the printed core layer (3) with a melamine formaldehyde (MF) resin; and
   coating a coating layer (2) on a top surface of the saturated printed core layer (3).
18. The process according to sentence 17, wherein the printed core layer (3) can be saturated with a melamine formaldehyde (MF) resin in a one-step or a two-step impregnation process, wherein in the first step of the two-step process, the saturating resin may comprise MF and UF resin in a MF:UF weight ratio of 0:100-100:0, or 90:10-10:90, or 98.5:1.5-99.75:0.25, and in the second step, the saturating resin may comprise MF and UF resin in a MF:UF weight ratio of 90:10-10:90, or 98.5:1.5-99.75:0.25, or 98.5:1.5-100:0.
19. In a fourth aspect, the present disclosure relates to a process for forming the article (7) according to any one of sentences 1-13, comprising
   laminating the coated overlay (1) to the panel substrate (4) optionally with the midlayer (5) between the overlay (1) and the substrate (4) and/or the backer sheet (6) on a bottom surface of the substrate (4), and thermally curing the article (7),
   wherein the laminating is performed at a temperature of from 140 to 200° C. at a pressure from 1-4 MPa for 20 to 600 seconds, preferably from 140-160° C. at a pressure from 1-4 MPa for 300-380 seconds, or preferably from 170-200° C. at a pressure from 1-4 MPa for seconds.
20. The process for forming the article (7) according to any one of sentences 17-19, may comprise laminating the coated overlay (1) to the panel substrate (4) optionally with the midlayer (5) between the overlay (1) and the substrate (4) and/or the backer sheet (6) on a bottom surface of the substrate (4), wherein the coated overlay (1) may have essentially no solvent, or may have no solvent prior to the laminating.
21. The process for forming the article (7) according to sentence 20, wherein the coated overlay (1) may have less than 0.1 wt. % of solvent or less than 0.01 wt. % of solvent prior to the laminating based on the total weight of the coated overlay (1).

### BRIEF DESCRIPTION OF THE DRAWINGS

FIG. 1 illustrates a cross sectional view of a coated overlay (1) of the prior art.

FIG. 2 illustrates a cross sectional view of a coated transparent overlay on a substrate according to the disclosure.

### DETAILED DESCRIPTION

The disclosure relates to an article (7) for indoor or outdoor use comprising a durable transparent overlay (1) affixed to a panel substrate (4), wherein the overlay (1) has improved mechanical properties and the overlay (1) provides the article (7) with long term resistance to surface damage from weather as well as wear and tear, and protection form aggressive chemicals.

An aspect of the disclosure is that it is possible to use non-standard resins with lower molar ratios which are more flexible, yield a color brilliance, and are characterized by a longer shelf-life of the article. Such resins also reduce the danger of micro-cracking in exterior applications. There is no need for a hard melamine surface as they are used in standard MF paper saturation since the surface is covered by a coating as described herein.

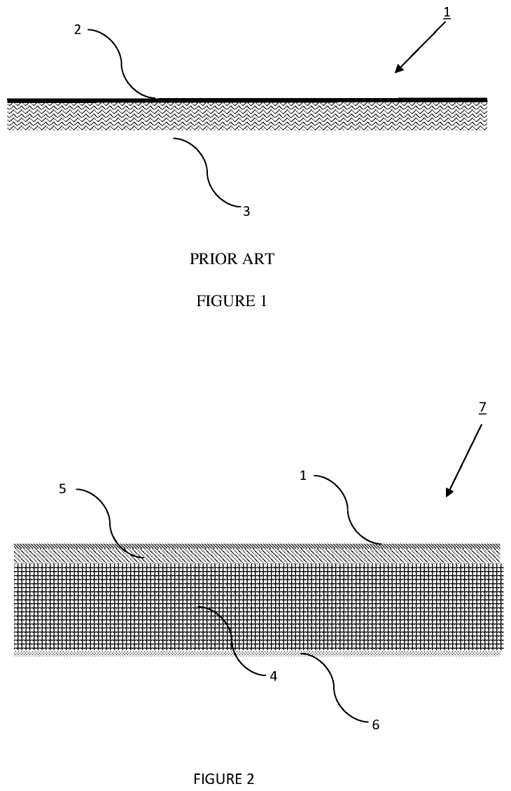

FIG. 1 is a depiction of a coated overlay (1). The overlay (1) comprises an untreated nonprinted alpha-cellulose core layer without fillers (3) that is saturated with a melamine-formaldehyde (MF) resin in a saturation process wherein the general process of saturating paper stock with a resin is well known in the art.

Base weight of the untreated cellulose web ranges can be from 15-80 g/m², preferably 20-70 g/m², more preferably 20-40 g/m². When an untreated cellulose web may be of high weight such as 65 g/m² or higher, the untreated cellulose web may not be translucent. However, even this high base weight paper will become transparent upon lamination. The cellulose web is untreated, i.e., the cellulose web is not subjected to a sizing, bonding, fortifying resin, glazing treatment and does not contain fillers before it is impregnated with the MF saturating resin. Such an untreated cellulose web is commercially available (for instance from Glatfelter Corporation).

Alternatively, the overlay (1) can be decor paper without filler. The decor paper can be ink-jet printed on a printer suitable for ink-jet printing of decor paper with water-based inks. The base weight of the decor paper without filler can be from 55-80 g/m², preferably 60-75 g/m², more preferably 60-70 g/m².

Since the overlay will be coated as described, the MF resin used to saturate the overlay can have a lower molar ratio of formaldehyde to melamine and can be plasticized to a higher degree than standard products used in the industry, which has the advantage that the products have a longer shelf life and are more flexible than standard MF impregnated overlays.

Before the cellulose web is impregnated with MF saturating resin, the untreated cellulose web can be optionally printed on, for instance by inkjet printing. Thereby the untreated cellulose web can be printed with full area designs or with partial area ornamental designs with water soluble inkjet inks with a single-pass or multi-pass industrial inkjet printer. As discussed below, the regions of the untreated impregnated cellulose web (3) that do not have printing thereon are transparent after lamination.

The core layer (3) is a printed or non-printed, untreated cellulose web saturated with a MF saturating resin that may have a range of molar ratios of from 1.5:1.0 to 1.8:1.0 of formaldehyde to melamine to a dry weight of 60-140 g/m², or a dry weight of 80-120 g/m², or a dry weight of 90-110 g/m². Preferably, the MF saturating resin is a standard MF saturating resin having a molar ratio of formaldehyde to melamine in the range of 1.6:1.0 to 1.65:1.0. The type of hardener and its content is adjusted in such a way that the finished overlay (1) can be laminated at temperatures ranging from 130-220° C., preferably 140-200° C. Residual moisture content can range from 6-8%, preferably 6.5-7.5%. Even though not widely used in the industry, urea or a mixture of urea and formaldehyde (UF), or a UF resin can be added to the MF saturating resin to reduce cost, and this invention also covers such systems. The printed or non-printed, untreated alpha-cellulose core layer (3) can be saturated with a melamine formaldehyde (MF) resin in a one-step or a two-step impregnation process, wherein in the first step of the two-step process, the saturating resin may comprise MF and UF resin in a MF:UF weight ratio of 0:100-100:0, or 90:10-10:90, or 98.5:1.5-99.75:0.25, and in the second step, the saturating resin may comprise MF and UF resin in a MF:UF weight ratio of 90:10-10:90, or 98.5:1.5-99.75:0.25, or 98.5:1.5-100:0. Preferably, the saturating resin does not contain urea formaldehyde resin because it may lead to some hydrolytic degradation, and as such, would only be used for interior applications, not exterior applications.

Herein the reference number “(3)” is used to refer to the untreated alpha-cellulose core layer before impregnation and after impregnation.

These processing conditions can provide the overlay (1) with high tear resistance and the ability to self-bond onto various porous substrates.

Subsequently, in a second step the protective top coating layer (2) can be applied in a one-step coating process, and subsequently dried. The coating has been described and disclosed in EP 0 846 135 B1/WO199749746A1 for the application as a protective top coat of HPL and compact boards. The coating can comprise a stoichiometric mixture of a (meth)acrylate resin with double bonds and at least two hydroxyl groups in a suitable solvent, and a multifunctional isocyanate as the hardener system. The advantage of such a co-polymer coating is that it undergoes a two-step cross-linking reaction at different stages of the process. The blend may also contain substances like amine light stabilizers (HALS) and Tinuvin types that prevent UV radiation from reaching the core of the paper and the substrate.

The protective top coating layer (2) can be applied and then dried and cured at a dry weight of 20-100 g/m², or 40-80 g/m², or 50 to 100 g/m², or 60-80 g/m², or preferably 60 to 90 g/m².

In a first curing step in the drying oven, the free hydroxyl groups can react with the aliphatic poly-isocyanate to form an acrylate—polyurethane copolymer containing methacrylate double bonds. The result is a dry coating layer with sufficient B-staged parts that can be stored in rolls for a second curing stage involving a full cure under heat and pressure.

In the second curing stage, which is usually carried out during the lamination of the overlay (1) under the influence of heat and pressure, the dried co-polymer in the coating layer (2) can start to melt and flow, and subsequently via the reaction of the methacrylate double bonds form a fully cross-linked high density polyurethane—methacrylate coat. Through the initial flow phase such surfaces can be embossed with detailed textures. If gloss is desired, gloss levels can be adjusted with the right press plate or texture foils from super matt to mirror gloss. The nonprinted areas of the overlay (1) can be either transparent before and after lamination, or it can transform from being translucent to transparent during lamination.

Overlays comprising an impregnated cellulose web are commercially available and are generally used for overlaying on top of melamine saturated decor paper in short cycle/low pressure lamination and HPL or continuous pressure laminate processes. Such products are distinguished from standard decor paper in that they do not contain any organic or inorganic filler to provide opacity as is found in the standard decor paper. Since the cellulose in the cellulose web (paper) and crosslinked MF resins have essentially the same refractive index, the impregnated cellulose web becomes fully transparent upon heat lamination. We have found that except for the transparency property, such cellulose webs can behave like standard decor paper.

An aspect of this disclosure is to use an impregnated cellulose web (3) as the carrier medium of the co-polymer coating (2). Thereby it is possible to bond on any substrate as described below without visually masking or obfuscating the substrate unless desired by printing a design/pattern on the untreated cellulose web before impregnation with the MF resin.

As shown in FIG. 2, an aspect of this disclosure includes an article (7) comprising the coated transparent overlay (1) on top of a panel substrate (4) of wood boards like particleboard, MDF, HDF plywood, or non-wood boards. Optionally, the substrate (4) can be covered with a midlayer (5) which is a veneer, decorative paper foil, melamine impregnated paper, MF resin impregnated paper, melamine urea formaldehyde (MUF) resin impregnated paper or medium density overlays (MDO). Preferably, the midlayer (5) is an oak veneer. Optionally, the substrate (4) is real wood veneer on MDF or particle board. Traditional MDO's do not retain print well, so the present disclosure provides, in part, a novel wear resistant MDO with a stable ink jet print. In an embodiment, the inventive article (7) is not a thermally fused laminate (TFL).

Regarding the use of MDO as a midlayer (5), MDO can be manufactured with thermosetting phenolic resin impregnated cellulose-fiber sheet or sheets bonded to the working face of plywood. The overlay layer may be formed of a sheet or sheets, containing not less than 27 wt. %, or not less than 30 wt. %, or not less than 35 wt. % phenolic resin content based on the volatile-free weight of fiber and resin, but exclusive of bond line. The thickness of resin-impregnated materials for each working face is preferably not less than mm (0.012 in.) thick after pressing and weighs not less than 280 g per m² (58 pounds per 1000 ft²), or not less than 300 g per m² (61.4 pounds per 1000 ft²), not less than 315 g per m² (64.5 pounds per 1000 ft²) including both resin and fiber, but exclusive of bond line. The resin-treated facing on the finished product may be suitable for painting, such as with a primer, which can be white or grey color. In an embodiment, the MDO is used as a concrete form. The concrete form MDO's preferably contain not less than 34 wt. %, or not less than 37 wt. %, or not less than 40 wt. % phenolic resin content based on the volatile-free weight of fiber and resin, but exclusive of bond line. The concrete form MDO's preferably contain a release agent.

An aspect of the present disclosure is a process for forming the article (7) comprising: printing on the untreated alpha-cellulose core layer (3); saturating the printed core layer (3) with a melamine formaldehyde (MF) resin; and coating a coating layer (2) on a top surface of the saturated printed core layer (3).

In another aspect of the present disclosure is a process for forming the article (7), comprising laminating the coated overlay (1) to the panel substrate (4) optionally with the midlayer (5) between the overlay (1) and the substrate (4) and/or the backer sheet (6) on a bottom surface of the substrate (4), wherein the laminating is performed at a temperature of from 140 to 200° C. and at a pressure of from 1-4 MPa for 20 to 600 seconds, preferably from 140-160° C. and at a pressure of from 1-4 MPa for 300-380 seconds, or preferably from 170-200° C. and at a pressure of from 1-4 MPa for 20-80 seconds. Preferably, the temperature is from 180 to 200° C. and at a pressure of from 2.2-2.7 MPa for 20 to 70 seconds, or the temperature is from 140 to 160° C. and at a pressure of from 0.5-1 MPa for 400 to 450 seconds, or the temperature is from 140 to 160° C. and at a pressure of from 2-3 MPa for 340 to 380 seconds. The lamination step can be performed with any standard TFL process press, or standard multi-opening HPL press, or a standard continuous pressure laminate (CPL) press without modification. The lamination can be performed at a high temperature for short periods, such as from 170-200 ° C. and at a pressure of from 1-4 MPa (preferably 2-3 MPa) for 20-80 seconds. Alternatively, the lamination can be performed at low temperatures for relatively longer periods, such as from 140-160° C. and at a pressure of from 1-4 MPa for 300-380 seconds.

In the process of forming the article (7), the coated overlay (1) can have essentially no solvent prior to the laminating step. Alternatively, the coated overlay (1) can have less than 0.1 wt. % of solvent or less than 0.01 wt. % of solvent prior to the laminating step based on the total weight of the coated overlay (1). Alternatively, the coated overlay (1) can have no solvent prior to the laminating step based on the total weight of the coated overlay (1).

The coated translucent overlay (1) can become transparent except for the printed regions upon lamination. To prevent warping a suitable backer sheet (6) is optionally applied using processes that are known in the art to the bottom surface of the substrate (4).

Texture and gloss level is determined by the surface structure of the press plate or by a textured release foil. No special treatment of press plate or release foil is necessary to achieve perfect release of the fully cured top coat. However, a high gloss release paper, a wood texture release paper, or an anti-fingerprint release paper can be used. The resulting surface of the article (7) can be very smooth with super matt surface. The press plate can be a mirror gloss press plate or a pearl matt press plate. The aim is that such surfaced substrates are used in exterior applications for façade elements, sidings, outdoor furniture, without the need for further protection.

The panel substrate (4) can be wood, plywood, or non-wood. Examples of plywood panel substrates (4) include okume plywood panels and birch plywood panels. Examples of a non-wood panel substrate (4) include any polymer based or mineral based boards such as HPL or gypsum boards that provide sufficient bonding with the melamine face of the coated overlay (1). The panel substrate (4) can be any dimension, such as up to 2500 mm×up to 2500 mm, or up to 1250 mm×up to 2500 mm, or up to 300 mm×up to 300 mm. The panel substrate (4) can be 1-25 mm in thickness, or 5-15 mm in thickness, or 8-12 mm in thickness.

The optional backer sheet (6) can be a bottom layer attached to a bottom surface of the substrate (4). The backer sheet (6) preferably is a MF impregnated paper overlay.

The resulting articles (7) can have at least one of the following properties:
a) Resistance to environmental impact;—pass at least 3000 hours artificial weathering according to EN ISO 16474-2
b) Mechanical properties sufficient to satisfy European Standard EN438 for high pressure laminates (HPL) of >4N;
c) Impact resistance of HPL;
d) Chemical and Stain resistance that meets SEFA 3 standard; and
e) Micro scratch resistance using Martindale test method that is better than micro-corundum fortified decor paper.

Preferably, the article (7) comprising the coating layer (2) has a resistance to staining ≥4, i.e. in particular 4 or 5, measured according to EN 438-2.26: 2019, has a scratch resistance rating of >4 measured in accordance with EN 438-2.25: 2019, and an exposure rating of >4 in accordance with EN 438-2.28:2019 (Resistance to UV light (Exterior grade laminates) and EN 438-2.29:2019 (Resistance to artificial weathering (Exterior grade laminates), both after 3000 hrs exposure time. More preferably, the article (7) has a weathering resistance as measured by EN 438-2.28-29:2019, to give no visible change, such as fading of the surface of the substrate (4) or of the midlayer (5), after 3000 hours. Ideally, the overlay (1) applied to the article (7) is capable of weather exposure with minimal loss in color and surface integrity for 10 years of outdoor exposure in a location in North East United States.

### EXAMPLES

### Formation of Coated Translucent Overlay (1)

### Example 1

In a process that is state of the art and well known in the field, translucent overlay with a base weight of 28 g/m² has been saturated with standard melamine formaldehyde resin with a molar ratio of formaldehyde to melamine of 1.62 to a final weight of 110 g/m². Commercial amine blocked acid hardener was used in a concentration to permit lamination onto substrates at temperatures ranging from 170-200° C. allowing for press times ranging from 20-80 seconds on a short cycle lamination press. The saturated overlay paper was dried to a residual moisture content of 6.5%.

The saturated overlay paper was subsequently coated with a liquid solution of the (meth)acrylate resin in butyl acetate through a spray nozzle, whereby an isocyanate hardener was added to the saturated overlay paper right before the spray nozzle. The liquid solution also contains substances like HALS and Tinuvin types that prevent UV radiation from reaching the core of the paper and the substrate. The liquid solution was sprayed onto the paper web and subsequently dried at 160° C. until dry to touch whereby the residual moisture content was kept above 5.5%. The finished coated overlay paper is dry to touch, can be stored as rolls or as sheets for a period of up to 6 months.

The thus prepared translucent overlay for high temperature application is commercially available and was purchased from a commercial paper saturation company in Germany

### Example 2

Overlay paper was impregnated and coated as in Example 1 with the difference that the concentration of the amine blocked acid hardener used for the saturation was reduced to permit lamination at presses with a temperature ranging from 140-160° C. with press times from 150 to 600 seconds.

The thus prepared translucent overlay for low temperature application is commercially available and was purchased from a commercial paper saturation company in Germany

### Formation of Article (7) Comprising the Coated Transparent Overlay (1)

### Example 3

The coated translucent overlay (1) of Example 1 is applied to an okume plywood panel substrate (4) in a single daylight press wherein the panel is 1250×2500 mm in dimensions using the following parameters:
Pressure=25 bar (1 bar=0.1 MPa)
Temperature=190° C.
Time=40 s

An anti-fingerprint release paper is used on a top surface of the coated translucent overlay (1) during press. The translucent overlay (1) becomes transparent during the press onto the okume plywood panel substrate (4). The resulting article (7) has a very smooth, super matt okume veneer surface without defects and has the following properties:
Scratch resistance, Grade 4 (EN 438-2:2019)
Micro scratch resistance Grade B3 (EN 16094:2021)
Water Vapor, Grade 5 (EN 438-2:2019)
Bonding—very good
Weathering EN 438-2.28-29:2019—no visible change after 3000 hours (hypothetical)

### Example 4

The coated translucent overlay (1) of Example 1 is applied to an okume plywood panel substrate (4) in a single daylight press to become transparent wherein the panel is 1250×2500 mm in dimensions using the following parameters:
Pressure=25 bar
Temperature=190° C.
Time=40 s

A high gloss release paper is used on a top surface of the coated transparent overlay (1) during press. The resulting article (7) has a very smooth, high gloss okume veneer surface without defects and the following properties:
Scratch resistance, Grade 4 (EN 438-2:2019)
Micro scratch resistance Grade B3 (EN 16094:2021)
Water Vapor, Grade 5 (EN 438-2:2019)
Bonding—very good
Weathering EN 438-2.28-29:2019)—no visible change after 3000 hours (hypothetical)

### Example 5

The coated translucent overlay (1) of Example 1 is laminated to a midlayer (5) which is a white primed medium density overlay (MDO) on an okume plywood panel substrate (4). The coated translucent overlay (1) becomes transparent during lamination. The okume plywood panel substrate (4) is 1250×2500 mm in dimensions. The lamination is performed using a single daylight press using the following parameters:
Pressure=25 bar
Temperature=190° C.
Time=40 s

A high gloss release paper is used on a top surface of the coated transparent overlay (1) during press. The resulting article (7) has a very smooth, high gloss surface that is white without defects and has the following properties:
Scratch resistance, Grade 4 (EN 438-2:2019)
Micro scratch resistance Grade B3 (EN 16094:2021)
Water Vapor, Grade 5 (EN 438-2:2019)
Bonding—very good
Weathering EN 438-2.28-29:2019—no visible change after 3000 hours (hypothetical)

### Example 6

The coated translucent overlay (1) of Example 2 is laminated to midlayer (5) which is a grey primed medium density overlay (MDO) on a birch plywood panel substrate (4) using a Laboratory press. The coated translucent overlay (1) becomes transparent upon lamination. The birch plywood panel substrate (4) is 300×300 mm in dimensions. The lamination is performed using the following parameters:
Pressure=7 bar
Temperature=150° C.
Time=420 s

A wood texture release paper is used on a top surface of the coated transparent overlay (1) during press. The resulting article (7) has a very smooth, grey structured surface without defects with excellent haptics and has the following properties:
Scratch resistance, Grade 4 (EN 438-2:2019)
Micro scratch resistance Grade B3 (EN 16094:2021)
Water Vapor, Grade 5 (EN 438-2:2019)
Bonding—very good
Weathering EN 438-2.28-29:2019—no visible change after 3000 hours (hypothetical)

### Example 7

The coated translucent overlay (1) of Example 2 is laminated on an oak veneer midlayer (5) on a medium density fiberboard (MDF) panel substrate (4) (10 mm in thickness) using a Laboratory press. The coated translucent overlay (1) becomes transparent upon lamination. The MDF panel substrate (4) is 300×300 mm in dimensions. The lamination is performed using the following parameters:
Pressure=25 bar
Temperature=150° C.
Time=360 s

An anti-fingerprint release paper is used on a top surface of the coated transparent overlay (1) during press. The resulting article (7) has a very smooth, super matt surface without defects and has the following properties:
Scratch resistance, Grade 4 (EN 438-2:2019)
Micro scratch resistance Grade B3 (EN 16094:2021)
Water Vapor, Grade 5 (EN 438-2:2019)
Bonding—very good
Weathering EN 438-2.28-29:2019—no visible change after 3000 hours (hypothetical)

### Example 8

The coated translucent overlay (1) of Example 1 is laminated to an oak veneer midlayer (5) on a MDF (10 mm in thickness) panel substrate (4) using a Laboratory press. The coated translucent overlay (1) becomes transparent upon lamination. The MDF panel substrate (4) is 300×300 mm in dimensions. The lamination is performed using a mirror gloss press plate and the following parameters:
Pressure=25 bar
Temperature=190° C.
Time=60 s

The resulting article (7) has a very smooth, almost mirror like gloss surface without defects and the following properties:
Scratch resistance, Grade 4 (EN 438-2:2019)
Micro scratch resistance Grade B3 (EN 16094:2021)
Water Vapor, Grade 5 (EN 438-2:2019)
Bonding—very good
Weathering EN 438-2.28-29:2019—no visible change after 3000 hours (hypothetical)

### Example 9

The coated translucent overlay (1) of Example 1 is laminated on an okume plywood panel substrate (4) and an overlay as a backer sheet (6) using a Laboratory press with a pearl mat press plate. The coated translucent overlay (1) becomes transparent upon lamination. The panel substrate (4) is 300×300 mm in dimensions. The lamination is performed using the following parameters:
Pressure=25 bar
Temperature=190° C.
Time=40 s

The resulting article (7) has a very homogenous pearly surface without defects and excellent haptics and the following properties:
Scratch resistance, Grade 4 (EN 438-2:2019)
Micro scratch resistance Grade B3 (EN 16094:2021)
Water Vapor, Grade 5 (EN 438-2:2019)
Bonding—very good
Weathering EN 438-2.28-29:2019—no visible change after 3000 hours (hypothetical

### Example 10

The untreated overlay paper as in example 1 is ink-jet printed on a printer suitable for ink-jet printing of decor paper with water-based inks. Two decors have been applied, one ornamental flower arrangement with ample non-printed regions, and a full-page wooden decor. The printed overlay subsequently is impregnated and coated as in examples 1 and 2.

The coated translucent overlay (1) of Example 1 is laminated on a plywood panel substrate overlaid with light grey MDO (6) using a Laboratory press with a pearl mat press plate. The coated translucent overlay (1) becomes transparent except for the printed regions upon lamination. The panel substrate (4) is 300×300 mm in dimensions. The lamination is performed using the following parameters:
Pressure=25 bar
Temperature=190° C.
Time=40 s

The ornamental flower decor with unprinted transparent regions are sharp and clear against the light grey background of the MDO. The full area wooden print is in appearance not distinguishable for a standard print decor and print-base paper. Both designs have a vivid appearance with very homogenous pearly surfaces without defects and excellent haptics and the following properties:
Scratch resistance, Grade 4 (EN 438-2:2019)
Micro scratch resistance Grade B3 (EN 16094:2021)
Water Vapor, Grade 5 (EN 438-2:2019)
Bonding—very good

### Example 11

A decor paper without filler with a raw weight of 65 g/m² is ink-jet printed on a printer suitable for ink-jet printing of decor paper with water-based inks. Two decors have been applied, one ornamental flower arrangement with ample non-printed regions, and a full-page wooden decor. The printed overlay subsequently is impregnated and coated as in examples 1 and 2. Due to the base weight being 65 g/m², the printed and coated overlay is not translucent. However, the regions that are not printed become transparent upon lamination.

The thus coated overlay is laminated on a plywood panel substrate overlaid with light grey MDO (6) using a Laboratory press with a pearl mat press plate. The panel substrate (4) is 300×300 mm in dimensions. The lamination is performed using the following parameters:
Pressure=25 bar
Temperature=190° C.
Time=40 s

The ornamental flower decor with transparent unprinted regions are sharp and clear against the light grey background of the MDO. The full area wooden print is in appearance not distinguishable for a standard print decor and print-base paper. Both designs have a vivid appearance with very homogenous pearly surfaces without defects and excellent haptics and the following properties:
Scratch resistance, Grade 4 (EN 438-2:2019)
Water Vapor, Grade 5 (EN 438-2:2019)
Bonding—very good

### ELEMENT NUMBERING IN THE DRAWINGS

### FIG. 1

1. Coated transparent overlay
2. Protective top layer
3. MF saturated alpha-cellulose core layer formed with a nonprinted alpha-cellulose web.

### FIG. 2

1. Coated transparent overlay as a top layer of the article
4. Substrate
5. Midlayer
6. Backer Sheet as a bottom layer of the article
7. Article

1. A thermally cured article (7) for indoor or outdoor use having resistance to damage from wear and tear and exposure to weather comprising:
a coated overlay (1) comprising an untreated alpha-cellulose core layer (3) that is saturated with a melamine formaldehyde (MF) resin and a coating layer (2) coated on a top surface of the core layer (3), said coating layer (2) comprising a polyurethane(meth)acrylate resin;
a panel substrate (4) of wood, plywood, or non-wood;
a midlayer (5) between the overlay (1) and the substrate (4), said midlayer (5) is a veneer, melamine impregnated paper, paper foil, melamine formaldehyde (MF) resin impregnated paper or melamine urea formaldehyde (MUF) resin impregnated paper or medium density overlay (MDO);
a backer sheet (6) is a bottom layer attached to a bottom surface of the substrate (4),
wherein the backer sheet (6) and midlayer (5) are optional.

2. The article (7) according to claim 1, wherein the untreated alpha-cellulose core layer (3) is a web having a base weight of 15-80 g/m².

3. The article (7) according to claim 1, wherein the untreated alpha-cellulose core layer (3) is saturated with a MF saturating resin to a dry weight of 80-120 g/m².

4. The article (7) according to claim 1, wherein the coating layer (2) is applied and then is dried and cured in an amount to give a dry weight of 20-100 g/m².

5. The article (7) according to claim 1, wherein the article comprises a backer sheet (6), or midlayer (5) or both a backer sheet (6) and midlayer (5).

6. The article (7) according to claim 1, wherein the coating layer (2) has at least one of the following properties:
a) Resistance to environmental impact;
b) Mechanical properties sufficient to satisfy European Standard EN438 for high pressure laminates (HPL) of >5N;
c) Impact resistance of HPL;
d) Chemical and Stain resistance that meets SEFA 3 standard; and
e) Micro scratch resistance using Martindale test method that is better than micro-corundum fortified decor paper.

7. The article (7) according to claim 1, wherein a surface of the coating layer (2) is chemical resistant with grade ≥4, i.e. in particular 4 or 5, measured according to EN 438-2.26: 2005, has a scratch resistance of ≥6N, measured in accordance with EN 438-2.25: 2005, and a change in the degree of gloss after exposure to weathering for 3500 hours in accordance with the EN 438-2.29: 2005 method, measured in accordance with EN ISO 2813 at an angle of of not more than 5 units.

8. The article (7) according to claim 1, wherein a surface of the coating layer has a change in the degree of gloss after exposure to weathering for 3500 hours in accordance with the EN 438-2.29 of not more than 20% compared to the initial value before weathering as set at 100%.

9. The article (7) according to claim 1, wherein the article has a weathering resistance as measured by EN 438-2.28-29:2019, to give no visible change after 3000 hours.

10. The article (7) according to claim 1, wherein the impregnated untreated alpha-cellulose core layer (3) is formed with a printed untreated alpha-cellulose web wherein regions that are not printed are transparent; or the impregnated untreated alpha-cellulose core layer (3) is formed with a nonprinted untreated alpha-cellulose web.

11. The article (7) according to claim 1, wherein the impregnated untreated alpha-cellulose core layer (3) is formed with a printed untreated alpha-cellulose web.

12. The article (7) according to claim 1, wherein the impregnated untreated alpha-cellulose core layer (3) is formed with a nonprinted untreated alpha-cellulose web.

13. The article (7) according to claim 1, wherein the untreated alpha-cellulose core layer (3) is saturated with a melamine formaldehyde (MF) resin in a one-step or a two-step impregnation process, wherein in the first step of the two-step process, the saturating resin comprises MF and UF resin in a MF:UF weight ratio of 0:100-100:0, and in the second step, the saturating resin comprises MF and UF resin in a MF:UF weight ratio of 98.5:1.5-100:0.

14. A product comprising the thermally cured article according to claim 1 forming an outer surface thereof, wherein the product is for indoor use and is a cabinet, kitchen counter, laboratory bench, or indoor flooring, or the product is for outdoor use and is fencing, door, an outdoor kitchen surface, a façade element, roofing, a garden shed surface, a tool shed surface or outdoor flooring.

15. The product according to claim 14, wherein the product is for indoor use and is a cabinet, kitchen counter, laboratory bench, or indoor flooring,

16. The product according to claim 14, wherein the product is for outdoor use and is fencing, a door, an outdoor kitchen surface, a façade element, roofing, a garden shed surface, a tool shed surface or outdoor flooring.

17. A process for forming the article (7) according to claim 1, comprising:
printing on the untreated alpha-cellulose core layer (3);
saturating the printed core layer (3) with a melamine formaldehyde (MF) resin; and
coating a coating layer (2) on a top surface of the saturated printed core layer (3).

18. The process according to claim 17, wherein the printed core layer (3) is saturated with a melamine formaldehyde (MF) resin in a one-step or a two-step impregnation process, wherein in the first step of the two-step process, the saturating resin comprises MF and UF resin in a MF:UF weight ratio of 0:100-100:0, and in the second step, the saturating resin comprises MF and UF resin in a MF:UF weight ratio of 98.5:1.5-100:0.

19. A process for forming the article (7) according to claim 1, comprising
laminating the coated overlay (1) to the panel substrate (4) optionally with the midlayer (5) between the overlay (1) and the substrate (4) and/or the backer sheet (6) on a bottom surface of the substrate (4), and thermally curing the article (7),
wherein the laminating is performed at a temperature of from 140 to 200° C. at a pressure from 1-4 MPa for 20 to 600 seconds.

20. The process for forming the article (7) according to claim 18, wherein the laminating of the coated overlay (1) to the panel substrate (4) optionally with the midlayer (5) between the overlay (1) and the substrate (4) and/or the backer sheet (6) on a bottom surface of the substrate (4), is performed with the coated overlay (1) having essentially no solvent prior to the laminating.

21. The process for forming the article (7) according to claim 20, wherein the coated overlay (1) has less than 0.1 wt. % of solvent prior to the laminating based on the total weight of the coated overlay (1).
